(19) United States
(12) Patent Application Publication
(10) Pub. No.: US 2003/0204155 A1
(43) Pub. Date: Oct. 30, 2003

(54) Oral cleansing device

(75) Inventor: Zoltan Egeresi, Santa Cruz, CA (US)

Correspondence Address: ZOLTAN EGERESI, 5500 COAST RD., SANTA CRUZ, CA, 95060, US

(73) Assignee: Zoltan Egeresi, Santa Cruz, CA

(21) Appl. No.: 10/137,172

(22) Filed: Apr. 30, 2002

(51) Int. Cl. A61H 7/00; A61C 17/00

(52) U.S. Cl. 601/165; 433/80

(57) ABSTRACT

This oral cleansing device assembly is an oral hygiene tool, which connects to the water faucet, uses normal water pressure in the system. Water is used for cleaning debris, scale, and plaque from the teeth, gums, tongue, and oral cavity in general. The oral cleansing device assembly consist of a diverter at the end of the faucet as an attachment or as a built in diverter, a straight non kinking vinyl tube and a jet-tip/nozzle. The vinyl tube is connected to the diverter screwed into the faucet as an after sale item or connects to a built in diverter connection in to the water mixer pipe before the aerator. Water temperature and flow is to be adjusted by the faucet valve, than the diverter valve is to be activated to commence the water flow to the oral cleansing assembly.

### References in U.S. Patent Documents

References in U.S. Patent Documents

| | | |
|---|---|---|
| 3667655 | June 1972 | Knieriem, Jr. |
| 3809977 | May 1974 | Balamuth et al. |
| 4958751 | September 1990 | Curtis et al. |
| 4973250 | November 1990 | Milman |
| 5125543 | June 1992 | Rohrabacher et al. |
| 5127831 | July 1992 | Bab. |
| 5137183 | August 1992 | Mikulec et al. |
| 5195664 | March 1993 | Rhea |

| | |
|---|---|
| 4,302,186; 4,229,634; 4,337,040; 4,989,590 | Waterpik |

### DESCRIPTION OF PRIOR ART

There are several types of oral cleaning devices on the market all are using a small cup to hold the water or mouth wash mixture, a fixed amount for oral rinsing. They use noisy, vibrating electric pump with adjustable pressure knob and plugged into some electrical source or battery powered with even smaller water container. Some oral cleaning devices use magnetic field manipulation with unproven benefits.

The water container needs to be filled every time before use, needs cleaning, rinsing and refilled if more water is needed for a proper oral rinsing. In case of pump driven oral cleaner devices like the Waterpik TM user is instructed not to use mouth wash because it will shorten the life of the pump.

The traditional way to keep teeth is by brushing with toothbrush and using tooth paste. This method is still a good one and strongly recommended by all dentists. Flossing is also a recommendation to remove plaque and any food debris from hard to reach areas from between the teeth.

This is where this invention, the Dental Water Jet comes in as a valuable oral cleaning device to clean hard to reach areas in the oral cavity. The Waterpik™ Dental Water jet with a pump using 110 V electricity is this device pumps the water from a small water container what needs to be filled and cleaned all the time and it has an adjustable pressure knob. A plastic coiled tube connects to a rigid water jet which is to be directed in the oral cavity where flossing or brushing can not do a proper job.

When using water jet, it strengthens, massages the gums, and cleans food particles from dental packets. Gingeval pockets and gum recession occurs because improper or infrequent tooth cleaning.

Irrigation can be defined simply as “the flushing of a specific site or area with a stream of fluid delivered by an irrigator”. In 1968, the first powered oral irrigation device, WaterPik.RTM. (Teledyne WaterPik), was accepted by the American Dental Association for its ability to remove food particles and debris from interdental areas and below the gum line. This device was widely recommended, particularly for orthodontic and prosthodontic patients and has expanded the usefulness of the irrigator in preventative care, beyond its application as a mechanism to simply flush away debris.

Irrigators designed for home care by the patient consist of a power driven pump or flexible syringe bulb and a tip. The early irrigator tips, designed for supragingival removal of debris were too large to penetrate the interdental space and or periodontal pockets.

However, one of the main drawbacks of oral hygiene techniques can be attributed to the non-handiness of most available oral irrigators or just being cumbersome, too big, multi step operation.

U.S. Pat. No. 5,127,831, corresponding to co-pending Israel Patent Application. No. 98355, discloses a novel irrigation probe, particularly suitable for use by a patient.

Another dental irrigation needle is disclosed in U.S. Pat. No. 4,993,941. Additionally, IMAX.RTM. Periotips.RTM. (SDI Group, Inc., IL U.S.A.) are used for in-office professional sub gingival irrigation. All of the known prior art irrigation probes can be used with various pumping devices containing the irrigation fluid, which may be water or medically compatible solutions. These devices include different manual and automatic syringes, spray injectors and mechanically or electrically driven pump systems. Another pumping device, stated to be suitable for use by a patient, is sold under the name Luer Syrette.RTM. (Perio Dental, Inc., Colorado USA). This pumping device consists of a compressible bulb, which has a narrow opening, and a hollow shaft. This Luer Syrette.RTM. is only operable when held in an upright position in addition, it requires the inclusion of an anti-suction valve, preventing suction of the irrigation fluid back into the bulb when pressure on the bulb is released.

Various fluid dispensing devices comprising a weighted dip tube assembly, some of them non-kinking tubes, which ensures that the free end of the dip tube is always submerged in the fluid to be dispensed.

### BRIEF DESCRIPTION

This is a low cost oral cleansing system with unlimited water supply source, no cups to fill, no cups to clean, uses no electricity, provides quiet operation. Constant water pressure is adjustable by the faucet valve of the water system in the home or attachable on the road in hotels as a portable device. Water is used for cleaning debris, scale, and plaque from the teeth, gums, tongue, and oral cavity in general. The oral cleansing device assembly consists of a diverter at the end of the faucet as an after sale attachment to an existent faucet, vinyl (or similar plastic) flexible non kinking tube connecting the diverter to the jet-tip/nozzle. The nozzle is a rigid PVC or similar plastic molded or assembled.

In case of a new faucet design diverter is built in before the aerator in the faucet's spout, which connects to the vinyl tube than to the water jet tip. For people with crowns, bridges it is the only way to reach properly under bridges to clean and flush out any decaying, bad smelling food particles for maintaining fresh breath. The most important advantage of this Water Jet invention beside the low cost is the ease of use.

Since no holding cups need to be filled with water and or cleaned, this is just a one step operation, pull the diverter knob for non stop oral rinsing. The ease of operation will encourage more frequent use, which will improve the gum's health and may prevent or any gum bleeding or gingivitis.

No electrical connections and no noisy pumps are used, cheaper and quiet operation, this invention provides unlimited supply of water quantity and wider range of water pressure.

This oral cleansing device assembly is attachable to a faucet, providing uninterrupted water supply, steady water pressure, no electricity is required, no pump is used, quiet operation.

It will improve on dental healthy removing all derbies from the mouth, plaque and scale resulting in fresher breath and improved general dental health.

The water jet will massage the gums, will help keeping the gums in good health in all areas where tooth brushes can not reach. For people with crowns, bridges it is the only way to reach properly under bridges to clean and flush out any decaying, bad smelling food particles for maintaining fresh breath.

The most important advantage of this Water Jet invention beside the low cost is the ease of use.

Since no holding cups need to be filled with water and or cleaned, this is just a one step operation, pull the diverter knob for non stop oral rinsing. It requires no special cleaning besides rinsing.

The ease of operation will encourage more frequent use which will improve the gum's health and may prevent or any gum bleeding or gingivitis.

Since no holding cups need to be filled with water and or cleaned, this is just a one step operation, pull the diverter knob for non stop oral rinsing. The ease of operation will encourage more frequent use, which will improve the gum's health and may prevent or any gum bleeding or gingivitis.

### DESCRIPTION OF THE DRAWINGS

This oral irrigator consists of the following parts: Diverter valve, Vinyl tube, Water jet.

FIG. 1. Irrigator attachment to existing faucet. Diverter valve 1 is attached to the end of the water faucet's Spout 5, diverter 1 is connected to the flexible vinyl tube 2 to the oral irrigator nozzle 3. To activate oral irrigator just open the faucet, set up a the temperature as desired with low water flow, place nozzle 3 in oral cavity, pull diverter knob 4 for cleaning the teeth.

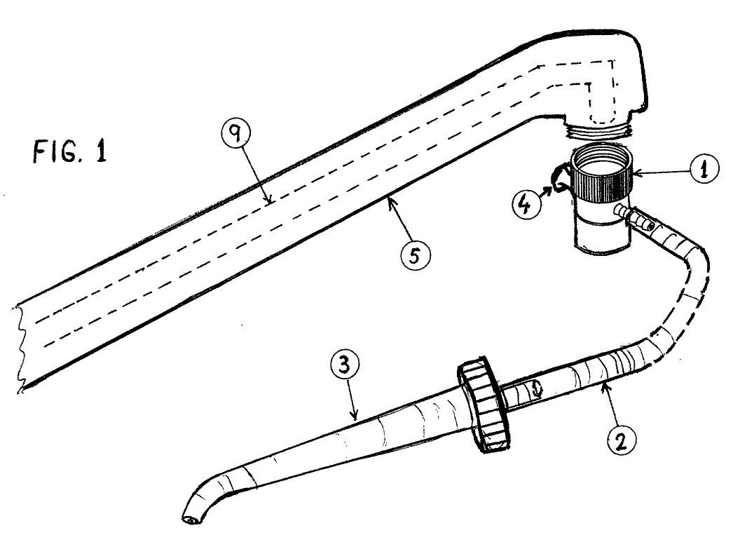

FIG. 2. Irrigator attachment to new design as claimed in the invention. At the tip of the faucet's spout Aerator 7 has a shut off valve 8 to direct all water to the barbed connection.

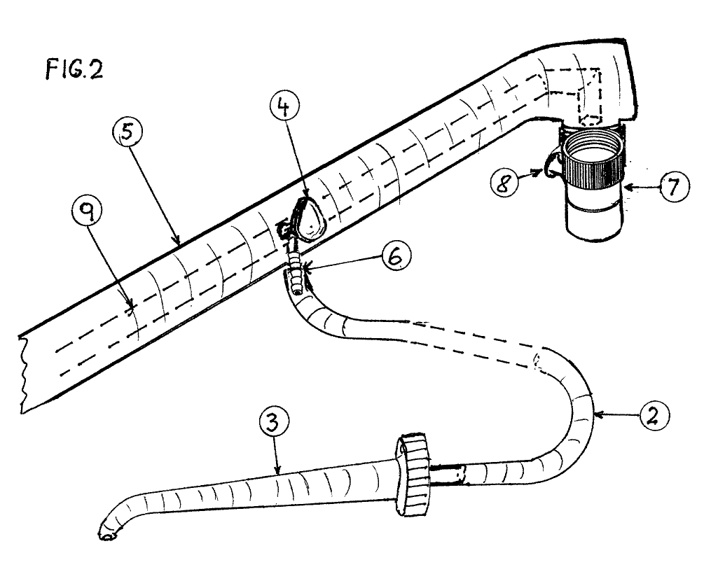

Vinyl tube 2 connects to the diverter's barbed connection 6, the other end of the vinyl tube connects to the oral irrigator's rigid nozzle 3.

To activate oral irrigator just open the faucet, set up a the temperature as desired with low water flow, place nozzle 3 in oral cavity, activate diverter knob 4 to direct water flow to vinyl tube 2 for cleaning the teeth, oral cavity.

Inside the spout 5 is the mixed hot water/cold water pipe 9 where the diverter 4 in the diverted position (flip or screw type) will divert the water to the flex tube 2 than to the oral irrigator nozzle 3.

While invention have been described in detail it is not limited thereto, and modifications and variations may be effected by one skilled in the art without departing from the spirit and scope of the invention.

What is claimed is:

1. Periodontal inflammation is one of the most common diseases of the adult population.
There are several types of oral cleaning, irrigating systems on the market, all are using a small cup or any kind of container elastic or other type to hold a fixed amount of water, uses electric pump with adjustable pressure knob, volume control and plugged into the electric source or in some cases battery powered with an even smaller water container. This device uses no mechanical or electricity driven pumping device or elastic water pressure generation or magnetic field manipulation of any kind.
This is a less expensive, low cost oral cleansing system with unlimited water supply source, no cups to fill, no cups to clean, uses no electricity, provides quiet operation, water pressure is adjustable by the faucet valve of the water system in the home or attachable on the road in hotels too.
Water is used for cleaning debris, scale, and plaque from the teeth, gums, tongue, and oral cavity in general. The oral cleansing device assembly consists of a diverter at the end of the faucet as an after sale attachment to an existent faucet or as a built in diverter for a new faucet type, vinyl (or similar plastic flexible) tube connecting the diverter to the jet-tip/nozzle.
The nozzle is a rigid PVC or similar plastic molded or assembled.
Molded nozzles are on the market sold by Conair Corp. as Waterpik™.
The vinyl tube in this invention is connected to the diverter which is screwed into the faucet as an after sale item or to a built in diverter connection in to the water mixer pipe before the aerator.
Water temperature and flow is to be adjusted by the faucet valve, than the diverter valve is to be activated (pulled) to commence the water flow to the oral cleansing assembly.
Water pressure keeps the diverter in the diverted (oral rinsing) position as long as it is needed.
Jet-tips will discharge the water into an oral cavity to clean food derbies from between teeth and from hard to reach places, massages gums to help to prevent gingivitis.
